(19) United States
(12) Patent Application Publication
(10) Pub. No.: US 2021/0356691 A1
(43) Pub. Date: Nov. 18, 2021

(54) ELASTIC ELEMENT, FOCUSING DEVICE AND CAMERA MODULE

(71) Applicant: TRULY OPTO-ELECTRONICS LTD., Guangdong (CN)

(72) Inventors: Rongfu XIE, Guangdong (CN); Jianhua LI, Guangdong (CN)

(73) Assignee: TRULY OPTO-ELECTRONICS LTD., Guangdong (CN)

(21) Appl. No.: 16/315,150

(22) PCT Filed: Feb. 6, 2018
(86) PCT No.: PCT/CN2018/075421

§ 371 Date: Jan. 3, 2019

(30) Foreign Application Priority Data
Jan. 19, 2018 (CN) 201810051582.4

(51) Int. Cl. G02B 7/04; G03B 13/34

(52) U.S. Cl. CPC G02B 7/04; G03B 13/34

(57) ABSTRACT

The invention discloses an elastic element, a focusing device and a camera module. The elastic element is used in the focusing device, and is of an annular structure made of an elastic material, the inner side of the elastic element is fixedly connected with a movable assembly of the focusing device, and the outer side of the elastic element is fixedly connected with a fixed assembly of the focusing device. The elastic element has the advantages of low requirements for manufacturing precision, high yield of products, long fatigue life, simplicity in assembling, good reliability and airtightness, and the like.

### BACKGROUND

### Technical Field

The invention relates to the field of camera shooting, in particular to an elastic element, a focusing device and a camera module.

### Background Art

At present, in the field of camera shooting of mobile phones, a voice coil motor is generally used for implementing focusing of a lens. An existing voice coil motor mainly comprises a movable assembly used for bearing a lens and being energized to generate a variable magnetic field and a fixed assembly which generates a permanent magnetic field, the movable assembly is accommodated in the fixed assembly, and the interaction force between the variable magnetic field of the movable assembly and the permanent magnetic field of the fixed assembly drives the movable assembly to move in the optical axis direction. Wherein the movable assembly is connected with the fixed assembly through an upper metal spring plate at the upper end and a lower metal spring plate at the lower end, and the elastic force of the upper metal spring plate and the lower metal spring plate and the interaction force between the permanent magnetic field and the variable magnetic field form a pair of balance forces for jointly controlling the movable assembly to be maintained in a focusing position.

Because a metal material is a hard material, a metal spring plate made of the metal material is good in linearity, but is short in fatigue life, moreover, as shown in FIG. 1, in order to enable the metal spring plate to be elastic, complicated spring wire structures 3′ need to be manufactured between an inner ring 2′ connected with the movable assembly and an outer ring 1′ connected with the fixed assembly to obtain elastic force in the optical axis direction, the complicated spring wire structures 3′ have quite high requirements for manufacturing precision to cause low yield of products, moreover, the airtightness is quite poor, a process of assembling the metal spring plate is complicated, and furthermore, connection reliability is also quite low.

### SUMMARY

In order to overcome shortcomings in the prior art, the invention provides an elastic element, a focusing device and a camera module. The elastic element has the advantages of low requirements for manufacturing precision, high yield of products, long fatigue life, simplicity in assembling, good reliability and airtightness, and the like.

The technical problems to be solved by the invention may be implemented through the following technical solutions:

An elastic element is used in a focusing device, and is of an annular structure made of an elastic material, the inner side of the elastic element is fixedly connected with a movable assembly of the focusing device, and the outer side of the elastic element is fixedly connected with a fixed assembly of the focusing device.

Further, the elastic element is provided with at least one folded ring structure concentric to the elastic element.

Further, the cross section of the folded ring structure is C-shaped, U-shaped, W-shaped or S-shaped.

A focusing device includes:

a movable assembly, used for generating a permanent magnetic field and bearing a lens;

a fixed assembly, used for being energized to generate a variable magnetic field;

an upper elastic element for connecting and fixing the upper end of the movable assembly and the upper end of the fixed assembly;

a lower elastic element for connecting and fixing the lower end of the movable assembly and the lower end of the fixed assembly; and

the interaction force between the permanent magnetic field and the variable magnetic field drives the movable assembly to move in the optical axis direction, and the elastic force of the upper elastic element and the lower elastic element and the interaction force between the permanent magnetic field and the variable magnetic field form a pair of balance forces for jointly controlling the movable assembly to be maintained in a focusing position, wherein the upper elastic element and/or the lower elastic element are/is the elastic element.

Further, the movable assembly is accommodated in the fixed assembly.

Further, the upper elastic element and/or the lower elastic element seal/seals a gap between the movable assembly and the fixed assembly.

Further, the movable assembly includes:

a carrier, used for bearing the lens and connecting and fixing the inner side of the upper elastic element and the inner side of the lower elastic element; and

a permanent magnet group, used for generating the permanent magnetic field and fixedly arranged on the carrier.

Further, the fixed assembly includes:

a base, used for connecting and fixing the outer side of the lower elastic element;

a shell, used for connecting and fixing the outer side of the upper elastic element and arranged on the base in a sleeving manner; and

a coil, used for being energized to generate the variable magnetic field and surrounding the periphery of the movable assembly.

Further, the fixed assembly further comprises an annular support, the coil is wound on the annular support, and the annular support is arranged on the base and surrounds the periphery of the movable assembly.

A camera module includes the focusing device.

The invention has the following beneficial effects: the elastic element is used in the focusing device and serves as the upper elastic element and/or the lower elastic element for connecting the fixed assembly and the movable assembly, the elastic element is made of the elastic material, the material has elasticity already, the circumstance that in the prior art, a metal spring plate only can be elastic through manufactured complicated spring wire structures is avoided, therefore, the requirements for manufacturing precision are low, and the yield of products is high; and moreover, because the spring wire structures are not required, a gapless, non-breakage and hollowing-free film-shaped structure or blocky structure can be manufactured between the inner side and the outer side of the elastic element to improve the airtightness of the focusing device, good dust prevention performance and water resistance are achieved, furthermore, the fatigue life of the elastic material is long, and the elastic material can be repeatedly telescopically pulled in a reciprocating manner.

### BRIEF DESCRIPTION OF THE DRAWINGS

FIG. 1 is a schematic view of an existing metal spring plate.

FIG. 2 is a schematic view of an elastic element provided by the invention.

FIG. 3 is an A-A view of the elastic element as shown in FIG. 2.

FIG. 4 is an exploded view of a focusing device provided by the invention.

### DETAILED DESCRIPTION OF THE EMBODIMENTS

The invention will now be described in detail in connection with accompanying drawings and embodiments.

### Embodiment 1

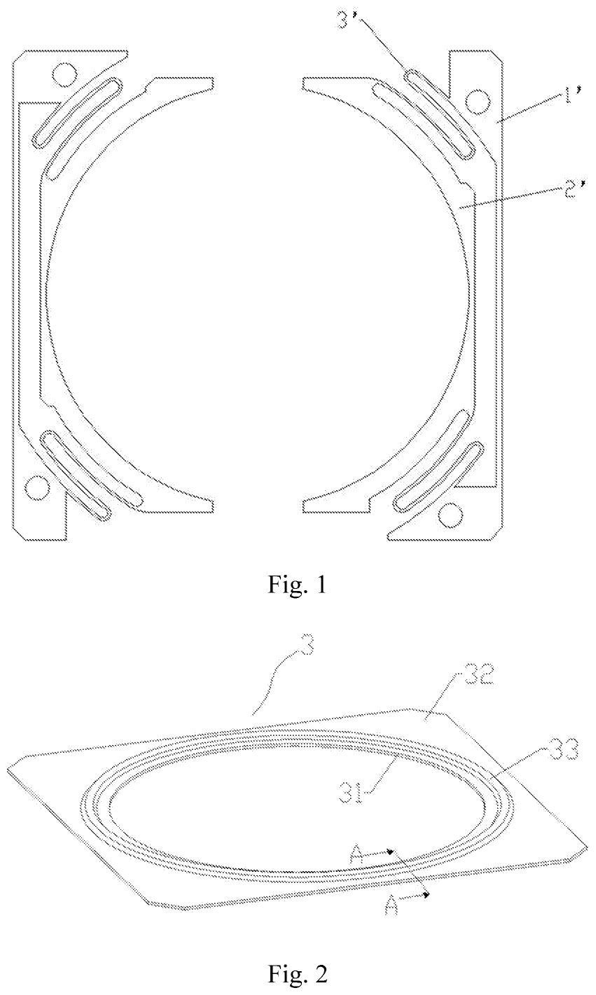

As shown in FIG. 2, an elastic element 3 is used in a focusing device, and is of an annular structure made of an elastic material, the inner side 31 of the elastic element 3 is fixedly connected with a movable assembly of the focusing device, and the outer side 32 of the elastic element 3 is fixedly connected with a fixed assembly of the focusing device.

The elastic element 3 is used in the focusing device and serves as an upper elastic element and/or a lower elastic element for connecting the fixed assembly and the movable assembly, the elastic element 3 is made of an elastic material, the material has elasticity already, the circumstance that in the prior art, a metal spring plate only can be elastic by manufactured complicated spring wire structures is avoided, therefore, the requirements for manufacturing precision are low, and the yield of products is high; and moreover, because the spring wire structures are not required, a gapless, non-breakage and hollowing-free film-shaped structure or blocky structure can be manufactured between the inner side 31 and the outer side 32 of the elastic element 3 to improve the airtightness of the focusing device, good dust prevention performance and water resistance are achieved, moreover, the fatigue life of the elastic material is long, for example, a rubber or plastic high polymer material has long fatigue life, the elastic material can be repeatedly telescopically pulled in a reciprocating manner, and the rubber high polymer material can even be widely used in a shock-absorbing system of a vehicle.

The elastic element 3 is of an annular structure, it does not mean that the outline of the inner side 31 and the outline of the outer side 32 are both circular, but it means that the elastic element 3 is of a similarly annular structure due to the fact that a light transmission hole is formed in the center of the elastic element 3, and the outline of the inner side 31 and the outline of the outer side 32 can be circular, and can also be polygonal, and it depends on fixing surfaces of the movable assembly and the fixed assembly of the focusing device.

The elastic element 3 can be made of a plastic material such as PET, PC, PEEK, PES, PSC or PEN or a rubber material such as thermoplastic dynamic vulcanized rubber or nitrile butadiene rubber, can also be made of a silica gel material certainly, and is most preferably made of the nitrile butadiene rubber which has small elasticity modulus and deforms easily after being stressed, the tensile strength of the nitrile butadiene rubber is high, local centralized plastic deformation is unlikely to cause, wherein the plastic material is manufactured preferably by, but not limited to a hot-blowing molding process, and the rubber material is manufactured preferably by, but not limited to, an injection molding process.

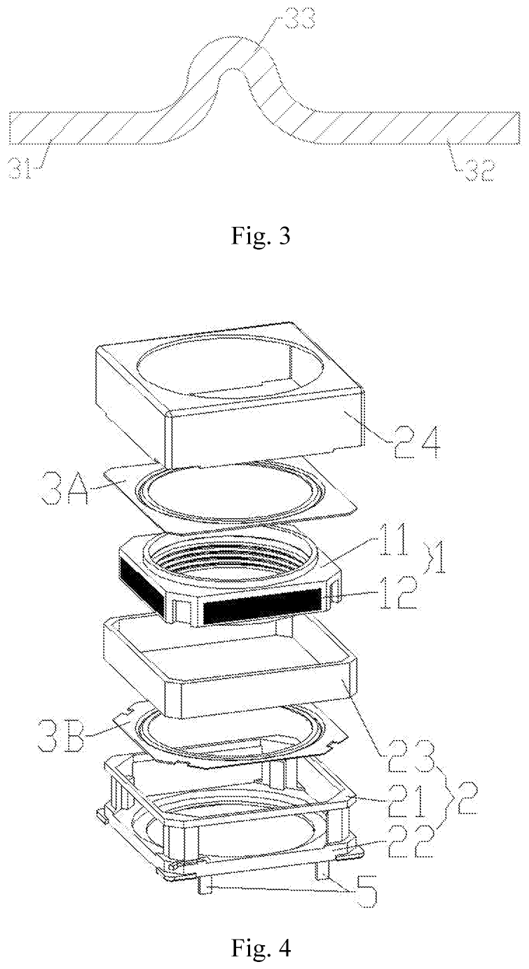

Preferably, the elastic element 3 is provided with at least one folded ring structure 33 concentric to the elastic element 3, as shown in FIG. 3, and the shape of the cross section of the folded ring structure 33 includes, but is not limited to, a C shape, a U shape, a W shape or an S shape.

By the folded ring structure 33, the elastic coefficient of the elastic element 3 in the optical axis direction can be reduced, thus, the elastic element 3 deforms easily when stressed in the optical axis direction, driving current required for the focusing device is reduced, and electricity is saved; and furthermore, the elastic coefficient of the elastic element 3 on an element plane can be increased, thus, the movable assembly is maintained on an optical axis, and adverse situations such as skewing, shaking and inclination are avoided.

The inner end of the folded ring structure 33 is connected with the inner side 31 of the elastic element 3 or another folded ring structure 33 adjacent to the inner end, and the outer end of the folded ring structure 33 is connected with the outer side 32 of the elastic element 3 or another folded ring structure 33 adjacent to the outer end.

The folded ring structure 33 not only can be protruded upwards, but also can be protruded downwards, can further be protruded upwards and downwards simultaneously certainly, but should keep away from other inner elements of the focusing device as far as possible to prevent structure interference on the other inner elements in a focusing process; and the width, the height and the like of the folded ring structure 33 should be set according to specific circumstances, and after the folded ring structure 33 with the suitable width, height and the like is elastically matched with the material of the elastic element 3, the driving current of the focusing device and the displacement of the movable assembly can be in positive correlation relation.

### Embodiment 2

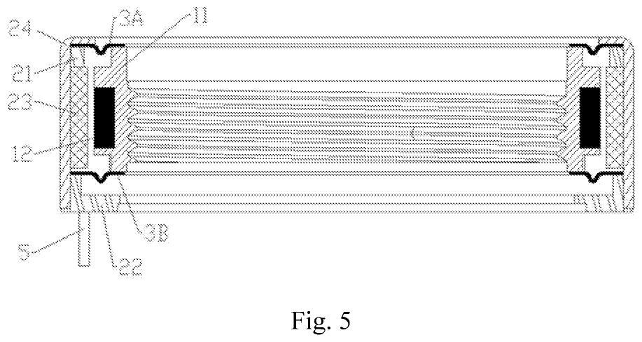

As shown in FIG. 4 and FIG. 5, a focusing device includes:

a movable assembly 1, used for generating a permanent magnetic field and bearing a lens;

a fixed assembly 2, used for being energized to generate a variable magnetic field;

an upper elastic element 3A, used for connecting the upper end of the movable assembly 1 and the upper end of the fixed assembly 2;

a lower elastic element 3B, used for connecting the lower end of the movable assembly 1 and the lower end of the fixed assembly 2; and

the interaction force between the permanent magnetic field and the variable magnetic field drives the movable assembly 1 to move in the optical axis direction, and the elastic force of the upper elastic element 3A and the lower elastic element 3B and the interaction force between the permanent magnetic field and the variable magnetic field form a pair of balance forces for jointly controlling the movable assembly 1 to be maintained in a focusing position, wherein the upper elastic element 3A and/or the lower elastic element 3B are/is the elastic element 3 in the embodiment 1.

In the embodiment, the upper elastic element 3A and the lower elastic element 3B are the elastic element 3 in the embodiment 1, but during actual use, one of the upper elastic element 3A and the lower elastic element 3B can be a metal spring plate in the prior art.

According to the focusing device, the upper elastic element 3A is used for connecting and fixing the upper end of the movable assembly 1 and the upper end of the fixed assembly 2, the lower elastic element 3B is used for connecting and fixing the lower end of the movable assembly 1 and the lower end of the fixed assembly 2, and the elastic force of the upper elastic element 3A and the lower elastic element 3B and the interaction force between the permanent magnetic field of the movable assembly 1 and the variable magnetic field of the fixed assembly 2 form a pair of balance forces for jointly controlling the movable assembly 1 to be maintained in a focusing position; and moreover, a focusing driving mode of enabling the fixed assembly 2 to generate the permanent magnetic field and energizing the movable assembly 1 to generate the variable magnetic field in the prior art is changed into a focusing driving mode of energizing the fixed assembly 2 to generate the variable magnetic field and enabling the movable assembly 1 to generate the permanent magnetic field, the coil 23 in the fixed assembly 2 is directly connected with pins 5 to be connected with a circuit board of a camera module to obtain electricity so as to generate the variable magnetic field, and thus, the problem that the lower elastic element 3B is not conductive, and cannot serve as a conductive element between the coil 23 and the pins 5 is solved.

In a focusing process, the interaction force between the permanent magnetic field of the movable assembly 1 and the variable magnetic field of the fixed assembly 2 drives the movable assembly 1 to move in the optical axis direction, and the upper elastic element 3A and the lower elastic element 3B apply electric force which is opposite to the movement direction of the movable assembly 1 to the movable assembly 1, the elastic force serves as reactive force of the interaction force between the permanent magnetic field and the variable magnetic field, and the interaction force and the reactive force jointly control the movable assembly 1 to be maintained in the focusing position.

The upper elastic element 3A and/or the lower elastic element 3B are/is connected and fixed to the movable assembly 1 and the fixed assembly 2 preferably by, but not limited to, a dispensing or dispensing and hot riveting mode.

The movable assembly 1 is accommodated in the fixed assembly 2.

The upper elastic element 3A and/or the lower elastic element 3B seal/seals a gap between the movable assembly 1 and the fixed assembly 2 to improve the dust prevention performance and water resistance.

The movable assembly 1 includes:

a carrier 11, used for bearing a lens and connecting and fixing the inner side of the upper elastic element and the inner side of the lower elastic element; and

a permanent magnet group 12, used for generating a permanent magnetic field and fixedly arranged on the carrier 11.

The permanent magnet group 12 comprises at least one pair of permanent magnets, each pair of permanent magnets is symmetrically and fixedly arranged on the carrier 11, the different pairs of permanent magnets are uniformly distributed, under the condition that driving force is enough, only a pair of permanent magnets of the permanent magnet group 12 requires to be used, and the two permanent magnets are symmetrically and fixedly arranged on the carrier 11; and in the embodiment, the permanent magnet group 12 comprises two pairs of permanent magnets, and the four permanent magnets are fixedly arranged on the carrier 11 in an offsetting manner at equal angles of 90 degrees.

The fixed assembly 2 comprises:

a base 22, used for connecting and fixing the outer side of the lower elastic element 3B;

a shell 24, used for connecting and fixing the outer side of the upper elastic element 3A, and arranged on the base 22 in a sleeving manner; and

a coil 23, used for being energized to generate a variable magnetic field and surrounding the periphery of the movable assembly 1.

The movable assembly 1 and the coil 23 are accommodated in a cavity formed by the base 22 and the shell 24, and the shell 24 is made of a non-magnetic-conductive material.

Two pins 5 are embedded in the base 22 during injection molding, and separately serve as a positive terminal and a negative terminal, one ends of the two pins 5 are exposed out of the top surface of the base 22 to be connected with the coil 23, and the other ends of the two pins 5 are exposed out of the bottom surface of the base 22 to be connected with a circuit board of a camera module.

The fixed assembly 2 further comprises: an annular support 21, the coil 23 is wound on the annular support 21, and the annular support 21 is arranged on the base 22 and surrounds the periphery of the movable assembly 1.

The upper portion of the annular support 21 is propped against the outer side of the upper elastic element 3A to press the outer side of the upper elastic element 3A on the top surface of the shell 24 only.

In the embodiment, an integrated bearing element is formed by the base 22 and the annular support 21 through an injection molding process, and during actual use, the base 22 and the annular support 21 can also be connected and fixed by processes such as dispensing, dissolution, clamped connection and riveted connection.

### Embodiment 3

A camera module comprises the focusing device in the embodiment 2.

The above embodiments are only used to illustrate the embodiment modes of the invention, descriptions of the embodiments are specific and detailed, but these should not be construed as limiting the scope of the patent of the invention, and any technical solutions obtained by the mode of equivalent substitution or equivalent transformation should be included in the scope of protection of the invention.

1. An elastic element, used in a focusing device, wherein the elastic element is of an annular structure made of an elastic material, an inner side of the elastic element is fixedly connected with a movable assembly of the focusing device, and an outer side of the elastic element is fixedly connected with a fixed assembly of the focusing device.

2. The elastic element according to claim 1, wherein the elastic element is provided with at least one folded ring structure concentric to the elastic element.

3. The elastic element according to claim 2, wherein the cross section of the folded ring structure is C-shaped, U-shaped, W-shaped or S-shaped.

4. A focusing device, comprising:
a movable assembly, used for generating a permanent magnetic field and bearing a lens;
a fixed assembly, used for being energized to generate a variable magnetic field;
an upper elastic element for connecting and fixing the upper end of the movable assembly and the upper end of the fixed assembly;
a lower elastic element for connecting and fixing the lower end of the movable assembly and the lower end of the fixed assembly; and
an interaction force between the permanent magnetic field and the variable magnetic field drives the movable assembly to move in an optical axis direction, and an elastic force of the upper elastic element and the lower elastic element and the interaction force between the permanent magnetic field and the variable magnetic field form a pair of balance forces for jointly controlling the movable assembly to be maintained in a focusing position, wherein the upper elastic element and/or the lower elastic element are/is the elastic element according to claim 1.

5. The focusing device according to claim 4, wherein the movable assembly is accommodated in the fixed assembly.

6. The focusing device according to claim 4, wherein the upper elastic element and/or the lower elastic element seal/seals a gap between the movable assembly and the fixed assembly.

7. The focusing device according to claim 4, wherein the movable assembly comprises:
a carrier, used for bearing the lens and connecting and fixing the inner side of the upper elastic element and the inner side of the lower elastic element; and
a permanent magnet group, used for generating the permanent magnetic field and fixedly arranged on the carrier.

8. The focusing device according to claim 4, wherein the fixed assembly comprises:
a base, used for connecting and fixing the outer side of the lower elastic element;
a shell, used for connecting and fixing the outer side of the upper elastic element and arranged on the base in a sleeving manner; and
a coil, used for being energized to generate the variable magnetic field and surrounding a periphery of the movable assembly.

9. The focusing device according to claim 8, wherein the fixed assembly further comprises an annular support, the coil is wound on the annular support, and the annular support is arranged on the base and surrounds the periphery of the movable assembly.

10. A camera module, comprising the focusing device according to claim 4.

11. The focusing device according to claim 5, wherein the upper elastic element and/or the lower elastic element seal/seals a gap between the movable assembly and the fixed assembly.

12. The focusing device according to claim 5, wherein the movable assembly comprises:
a carrier, used for bearing the lens and connecting and fixing the inner side of the upper elastic element and the inner side of the lower elastic element; and
a permanent magnet group, used for generating the permanent magnetic field and fixedly arranged on the carrier.

13. The focusing device according to claim 5, wherein the fixed assembly comprises:
a base, used for connecting and fixing the outer side of the lower elastic element;
a shell, used for connecting and fixing the outer side of the upper elastic element and arranged on the base in a sleeving manner; and
a coil, used for being energized to generate the variable magnetic field and surrounding a periphery of the movable assembly.
